(19) United States
(12) Patent Application Publication
(10) Pub. No.: US 2013/0346183 A1
(43) Pub. Date: Dec. 26, 2013

(54) ENTITY-BASED AGGREGATION OF ENDORSEMENT DATA

(71) Applicants: ASHOK K. CHANDRA, SARATOGA, CA (US); OLIVIER J. DABROWSKI, GILROY, CA (US); DAVID JAMES GEMMELL, ALAMO, CA (US); BENJAMIN RUBINSTEIN, MOUNTAIN VIEW, CA (US)

(72) Inventors: ASHOK K. CHANDRA, SARATOGA, CA (US); OLIVIER J. DABROWSKI, GILROY, CA (US); DAVID JAMES GEMMELL, ALAMO, CA (US); BENJAMIN RUBINSTEIN, MOUNTAIN VIEW, CA (US)

(73) Assignee: MICROSOFT CORPORATION, Redmond, WA (US)

(21) Appl. No.: 13/531,320

(22) Filed: Jun. 22, 2012

(51) Int. Cl. G06Q 30/02

(52) U.S. Cl. 705/14.41

(57) ABSTRACT

Systems, methods, and computer-readable storage media for performing entity-based aggregation of endorsement data are provided. Entity-endorsement data is received from a plurality of different sources, e.g., websites, web pages, database records, files, data feeds, or networks. Entity resolution is then performed to identify like entities. Once the entities are resolved, the relevant endorsement data from each appropriate source is aggregated. The aggregated endorsement data may then be presented with or without an identification of the sources from which the data was aggregated. In this way, sparseness and fragmentation of endorsement data are mitigated and a more complete picture of an entity's endorsement status may be seen.

### BACKGROUND

Many initiatives are moving the Internet toward being a more social tool. Chief among them is the “open graph” offered by FACEBOOK, INC. of Palo Alto, Calif., which allows website administrators to place endorsement or “Like” buttons on their websites. By selecting a “Like” button, users share with their social network connections that they positively endorse the represented entity (for instance, a movie, a celebrity, etc.). Further, the “Like” event is subsequently surfaced on the selecting user's online profile or wall. Moreover, this signal may be broadcast publicly, as the “Like” counter on a page, representing the number of times the page (or entity) is positively endorsed. Such crowd-sourced entity ratings have the potential for dramatically changing the way users navigate and interact with the Web.

However, a significant drawback with this resource is that endorsement data tends to be very sparse (few “likes” per page, and a high variance of “likes”) and fragmented, that is, the same entity may be represented by several pages within one website or pages across many sites, which dilutes the available endorsement data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, facilitating the aggregation of endorsement data derived from multiple sources that represent the same entity. Entity-endorsement data is received from a plurality of different sources. Entity resolution is then performed to identify like entities. Endorsement data pertaining to a resolved entity and derived from each appropriate source is then merged or aggregated such that endorsement data pertaining to a particular entity but derived from disparate sources may be accumulated in one place. The aggregated endorsement data may then be presented with or without an identification of the sources from which the data was aggregated. In this way, sparseness and fragmentation of endorsement data are mitigated and a more complete picture of an entity's endorsement status may be seen.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a block diagram of an exemplary entity resolution system that may be utilized in accordance with an embodiment of the present invention;

FIG. 4 is a schematic diagram illustrating an exemplary screen display wherein aggregated endorsement information for a resolved, top-ranking entity is shown, in accordance with an embodiment of the present invention;

FIG. 5 is a schematic diagram illustrating an exemplary screen display wherein the indicator “More Details” shown in FIG. 4 is acted upon to surface a detailed view for all Uniform Resource Locators (URLs) associated with the resolved entity and an actual or estimated number of favorable endorsements associated with each contributing source, in accordance with an embodiment of the present invention;

FIG. 6 is a schematic diagram illustrating an exemplary screen display showing the source from which a social network connection of the user endorsed the shown resolved entity, in accordance with an embodiment of the present invention;

FIG. 7 is a schematic diagram illustrating an exemplary screen display showing search results filtered by the presence of associated entity endorsement data, in accordance with an embodiment of the present invention;

FIG. 8 is a schematic diagram illustrating an exemplary screen display showing aggregate endorsements for a plurality of entities that are part of a category or group, in accordance with an embodiment of the present invention;

FIG. 9 is a flow diagram showing an exemplary method for performing entity-based aggregation of endorsement data, in accordance with an embodiment of the present invention; and

FIG. 10 is a flow diagram showing an exemplary method for performing entity-based aggregation of endorsement data for similar entities, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, performing entity-based aggregation of endorsement data derived from multiple sources. An “entity,” in accordance with embodiments of the present invention, is a description of some sort of real-world object or item. That is, an entity is a representation of a real-world concept. Entities sharing common attributes may be grouped into entity types. “Endorsement data,” as utilized herein, may take a variety of forms including, without limitation, liking, sharing, tagging, commenting on, reading, viewing, selecting, bookmarking, saving, tweeting, etc. Endorsements may be favorable or unfavorable. Endorsement data may also encompass rating data wherein the strength of a favorable or unfavorable endorsement is indicated by a scale of some sort, or verbal/textual annotations indicating sentiment.

In accordance with embodiments hereof, upon receipt of endorsement data from multiple sources, entity resolution is performed to identify like entities. Sources may include, without limitation, websites, web pages, database records, files, data feeds, and networks. Once the entities are resolved, the relevant endorsement data from each appropriate source is aggregated. The aggregated endorsement data may then be presented with or without an identification of the sources from which the data was aggregated.

Accordingly, one embodiment of the present invention is directed to one or more computer-readable storage media storing computer-useable instructions that, when used by one or more computing devices, cause the one or more computing devices to perform a method for performing entity-based aggregation of endorsement data. The method includes receiving attribute data about an entity, the attribute data being derived from a plurality of sources at least a portion of which are associated with endorsement data pertaining to the entity; aggregating at least a portion of the attribute data into resolved entity data pertaining to the entity; aggregating at least a portion of the endorsement data into resolved endorsement data pertaining to the entity; and storing the resolved entity data and the resolved endorsement data in association with one another and in association with an entity identifier for the entity.

In another embodiment, the present invention is directed to a system for performing entity-based aggregation of endorsement data. The system includes a computing device associated with a server having one or more processors and one or more computer-readable storage media and a data store coupled with the server. The server is configured to receive a search query from a user, at least a portion of the search query pertaining to an entity; receive attribute data about the entity, the attribute data being derived from a plurality of sources at least a portion of which are associated with endorsement data pertaining to the entity; aggregate at least a portion of the attribute data into resolved entity data pertaining to the entity; aggregate at least a portion of the endorsement data into resolved endorsement data pertaining to the entity; and transmit at least a portion of the resolved entity data and at least a portion of the resolved endorsement data for presentation in association with a search engine results page.

In yet another embodiment, the present invention is directed to a method being performed by one or more computing devices including at least one processor, for performing entity-attribute-based aggregation of endorsement data. The method includes receiving a search query from a user, at least a portion of the search query pertaining to an entity-attribute that is common among a plurality of entities; receiving endorsement data pertaining to at least a portion of the plurality of entities, the endorsement data being derived from a plurality of sources; aggregating at least a portion of the endorsement data into resolved endorsement data pertaining to the at least a portion of the plurality of entities; and transmitting at least a portion of the resolved endorsement data and an identifier of one or more entities of the at least a portion of the plurality of entities for presentation in association with a search engine results page.

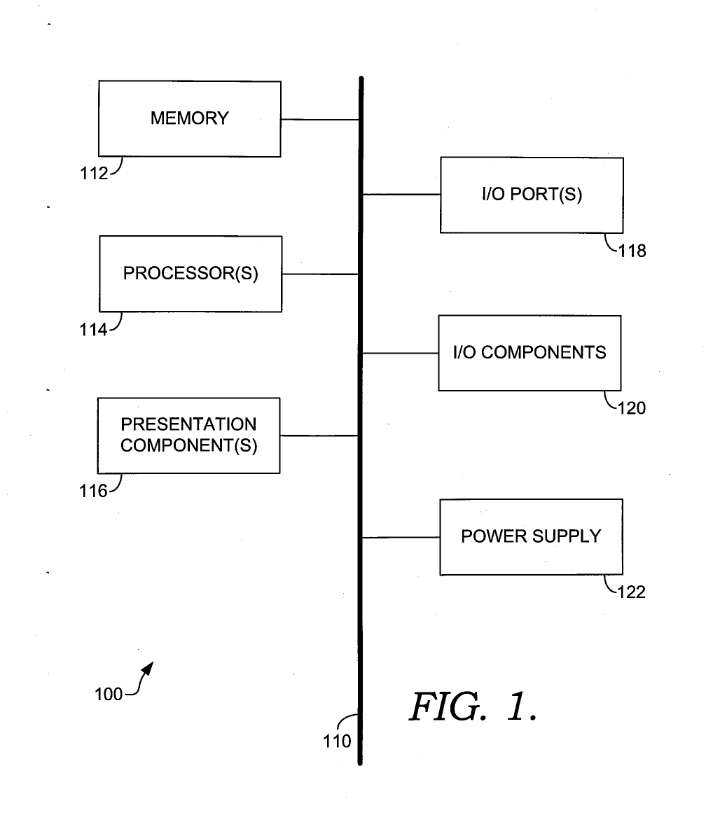

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network.

In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

With continued reference to FIG. 1, computing device 100 includes a bus 110 that directly or indirectly couples the following elements: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include solid state memory, hard drives, optical disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, etc.

As previously mentioned, embodiments of the present invention are generally directed to systems, methods, and computer-readable storage media for, among other things, facilitating the aggregation of endorsement data derived from multiple sources that represent the same entity. Entity-endorsement data is received from a plurality of different sources, for instance, websites, web pages, database records, files, data feeds, networks, and the like. Entity resolution is then performed to identify like entities. Once the entities are resolved, the relevant endorsement data from each appropriate source is aggregated. The aggregated endorsement data may then be presented in a single entity view with or without an identification of the sources from which the data was aggregated. In this way, sparseness and fragmentation of endorsement data are mitigated and a more complete picture of an entity's endorsement status may be seen.

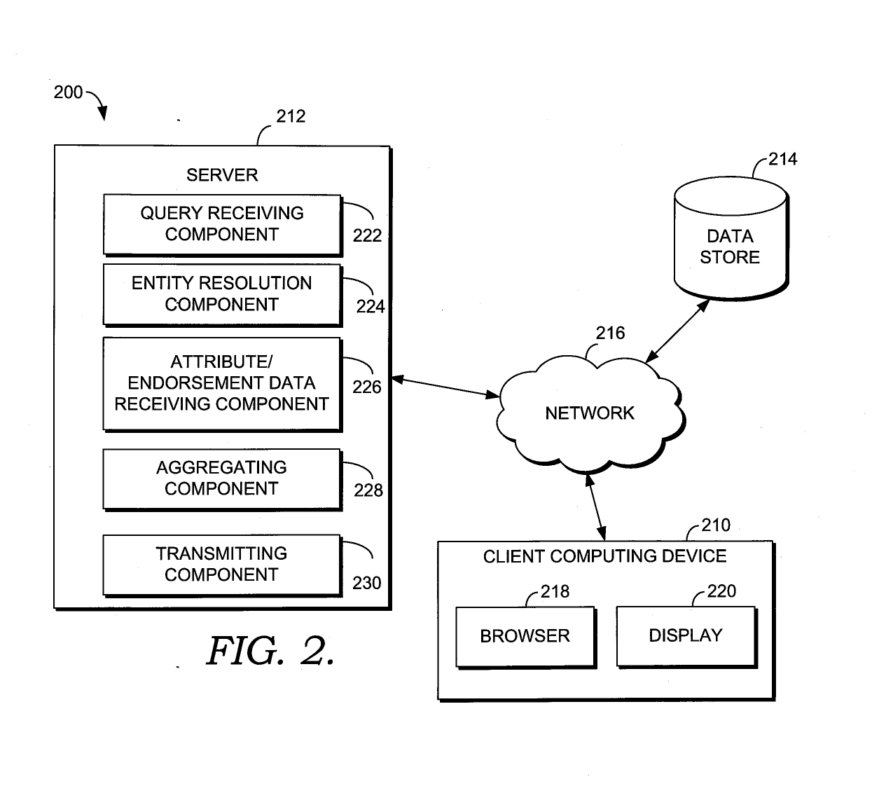

Referring now to FIG. 2, a block diagram is provided illustrating an exemplary computing system 200 in which embodiments of the present invention may be employed. Generally, the computing system 200 illustrates an environment in which entity-based aggregation of endorsement data may be performed. Among other components not shown, the computing system 200 generally includes a client computing device 210, a server 212, and a data store 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of client computing devices and servers may be employed in the computing system 200 within the scope of embodiments of the present invention. Each may comprise a single device/interface or multiple devices/interfaces cooperating in a distributed environment. For instance, the server 212 may comprise multiple devices and/or modules arranged in a distributed environment that collectively provide the functionality of the server 212 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client computing device 210, as an Internet-based service, or as a module inside the server 212. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines or user computing devices. By way of example only, the server 212 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The client computing device 210 may include any type of computing device, such as the computing device 100 described with reference to FIG. 1, for example. Generally, the client computing device 210 includes a browser 218 and a display 220. The browser 218, among other things, is configured to render search engine home pages (or other online landing pages), and render search engine results pages having aggregated endorsement data in association with the display 220 of the client computing device 210. The browser 218 is further configured to receive user input of requests for various web pages (including search engine home pages), receive user inputted search queries (generally inputted via a user interface presented on the display 220 and permitting alpha-numeric and/or textual input into a designated search box) and to receive content for presentation on the display 220, for instance, from the server 212. It should be noted that the functionality described herein as being performed by the browser 218 may be performed by any other application capable of rendering Web content. Any and all such variations, and any combination thereof, are contemplated to be within the scope of embodiments of the present invention.

The server 212 is configured to receive and respond to requests that it receives from components associated with user computing devices, for instance, the browser 218 associated with the client computing device 210. Those skilled in the art of the present invention will recognize that the present invention may be implemented with any number of searching utilities. For example, an Internet search engine or a database search engine may utilize the present invention. These search engines are well known in the art, and commercially available engines share many similar processes not further described herein.

As illustrated, the server 212 includes a query receiving component 222, an entity resolution component 224, an attribute/endorsement data receiving component 226, an aggregating component 228, and a transmitting component 230. The illustrated server 212 also has access to a data store 214. The data store 214 is configured to store information pertaining to search queries, entities, and endorsement data. In various embodiments, such information may include, without limitation, search query logs, an index of entity types and corresponding entities, and an index or other listing of sources determined to be malicious. In embodiments, the data store 214 is configured to be searchable for one or more of the items stored in association therewith. It will be understood and appreciated by those of ordinary skill in the art that the information stored in association with the data store 214 may be configurable and may include any information relevant to search queries, entity types and corresponding entities, and endorsement data. The content and volume of such information are not intended to limit the scope of embodiments of the present invention in any way. Further, though illustrated as a single, independent component, the data store 214 may, in fact, be a plurality of storage devices, for instance a database cluster, portions of which may reside in association with the server 212, the client computing device 210, another external computing device (not shown), and/or any combination thereof.

The query receiving component 222 of the server 212 is configured to receive requests for presentation of search results that satisfy an input search query, at least a portion of the search query pertaining to an entity. Typically, such a request is received via a browser associated with a client computing device, for instance, the browser 218 associated with the client computing device 210. It should be noted, however, that embodiments of the present invention are not limited to users inputting a search query into a traditional query-input region of a screen display.

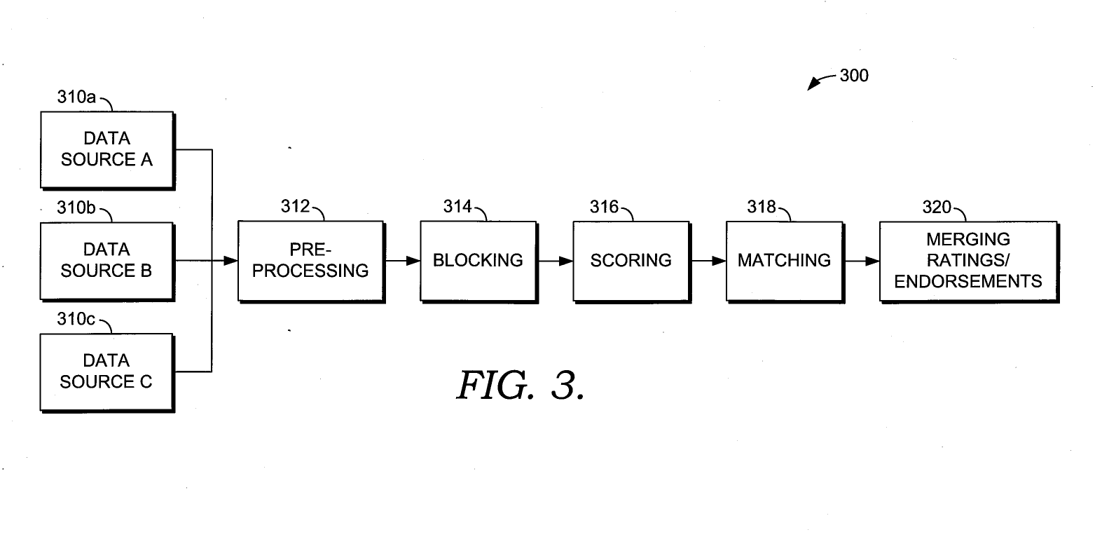

The entity resolution component 224 is configured to resolve entity data received from a plurality of sources. An exemplary entity resolution system 300 in accordance with embodiments of the present invention is shown in the block diagram of FIG. 3. Generally, entities (i.e., real-world objects), are represented by their attributes. For instance, a movie entity may be represented by such attributes as the movie's title, release year, directors, cast, synopsis, and the like. As shown in FIG. 3, such attributes or descriptions of entities are received from a plurality of data sources, Data Source A 310a, Data Source B 310b, Data Source C 310c. In accordance with embodiments of the present invention, at least a portion of the data sources are associated with endorsement data.

The attributes for the represented entities are cleaned and normalized by pre-processing 312. Blocking 314 is then performed to determine which pairs of entity representations ought to be thoroughly compared to one another. Entity pairs for comparison may come from distinct data sources if such sources do not contain duplications. However, this is generally not the case (e.g., FACEBOOK fan pages contain duplicates) and thus, in general, blocking 314 outputs pairs of entities from both distinct sources and the same source. Scoring 316 then assesses the attributes of entity pairs, computes scores on a per attribute basis, (e.g., edit distance between movie titles, difference between release years, etc.), and combines the attribute scores into a total similarity score. In the matching step 318, the similarity score may be compared to a predefined threshold to produce matching pairs, or a more sophisticated graph matching problem may be solved. Finally, merging 320 is performed wherein matched entity representations are combined into a single integrated overall representation for an entity. Merging may involve taking the union over all attribute values or voting in some way so as to come to a consensus on the true attribute values of an entity. In accordance with embodiments hereof, the endorsement data pertaining to the underlying entity is also merged or aggregated.

A large number of merging or aggregation schemes are possible and the following examples are described herein for illustrative purposes only and are not intended to limit the scope of the present invention in any way. At the simplest end of the spectrum, the aggregate number of favorable endorsements or ratings for an entity may be taken as the sum number of ratings or mean rating from the matched entity representations respectively. More generally, any “estimator of location” could be used for ratings such as the median, or any other statistic similar to the mean but that may be more robust to outliers (for example).

Indeed, outliers, and even malicious endorsements, motivate other kinds of aggregation methods as well. For instance, known “like” farms produce automated favorable endorsements for pay. Aggregation methods may be utilized to detect sets of such endorsements and remove them from aggregation, for instance, by noting IP addresses producing inordinate numbers of favorable endorsements or addresses that correlate with endorsements known to be spam. Unfavorable endorsement or rating data may be source-specific, either due to malicious or benign reasons, and simple machine learning methods may be utilized to learn which sources have poor quality so that aggregation of favorable endorsements and ratings can down-weigh such sources.

Aggregation could also be done on the basis of the set of all people that favorably endorse a given entity at various sources. In this instance, if a user were to search for an entity, for instance, “James Cameron movies,” then in accordance with embodiments hereof, the user may be preferentially shown movies endorsed by social network connections of the user, regardless of the source in association with which such connections endorsed the movie.

Many of the described schemes for aggregating favorable and unfavorable endorsement data may be utilized to aggregate ratings also. However, ratings by one person on multiple entities (e.g., movies) may not match up in scale to those ratings of another person. Thus, tools such as collaborative filtering and recommendation systems (e.g., those used by sites such as NETFLIX) may be employed to normalize ratings so that they can be aggregated in a sensible way.

Where endorsements are textual or verbal, aggregation may also be done on the basis of classifiers or extractors of sentiment from the endorsement, whether positive or negative, and such sentiments could then be aggregated. For example, a user may comment on a web page for a restaurant that it is good for a night out for couples; and another user might tweet about the same restaurant mentioned on a different web page has having good low lighting; and these could be aggregated via entity resolution for that restaurant entity as positive recommendations for a romantic dinner outing.

Referring back to FIG. 2, the attribute/endorsement data receiving component 226 of the server 212 is configured to receive attribute data about an entity, the attribute data being derived from a plurality of sources. In accordance with embodiments hereof, at least a portion of the received attribute data about an entity is associated with endorsement data pertaining to the entity. Thus, the attribute/endorsement data receiving component 226 is additionally configured to receive endorsement data relating to entities.

The aggregating component 228 is configured to aggregate at least a portion of the received attribute data into resolved entity data pertaining to the associated entity. The aggregating component 228 is further configured to aggregate at least a portion of the endorsement data for a given entity into resolved endorsement data pertaining to the entity.

It should be noted that both components 226 and 228 may simply be included in the entity resolution component 224 rather than being separate components as illustrated herein, so long as the selected arrangement results is not only the entities themselves being resolved but also the associated endorsement data. Any and all such variations, and any combination thereof, are contemplated to be within the scope of embodiments of the present invention.

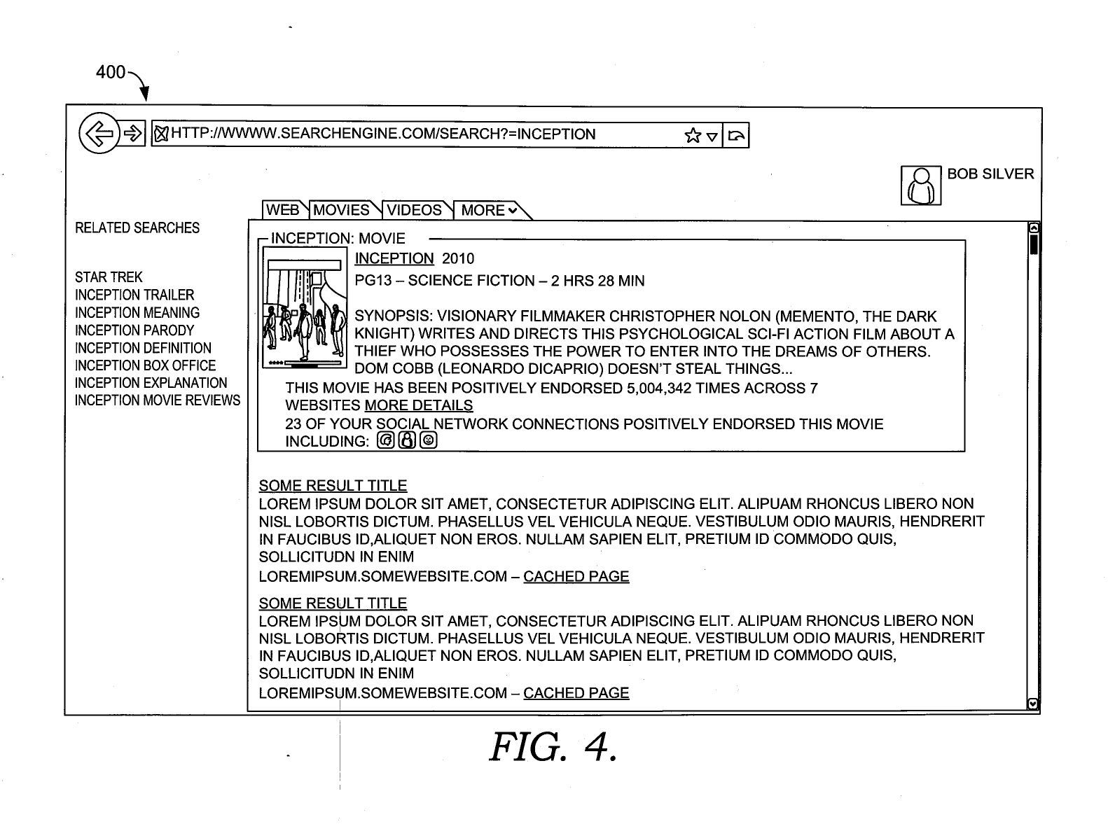

The transmitting component 230 is configured to transmit at least a portion of the resolved entity data and resolved endorsement data for presentation, for instance, in association with a single entity view on a search engine results page. Exemplary screen displays showing illustrative endorsement resolution presentations are more fully described below with respect to FIGS. 4-8.

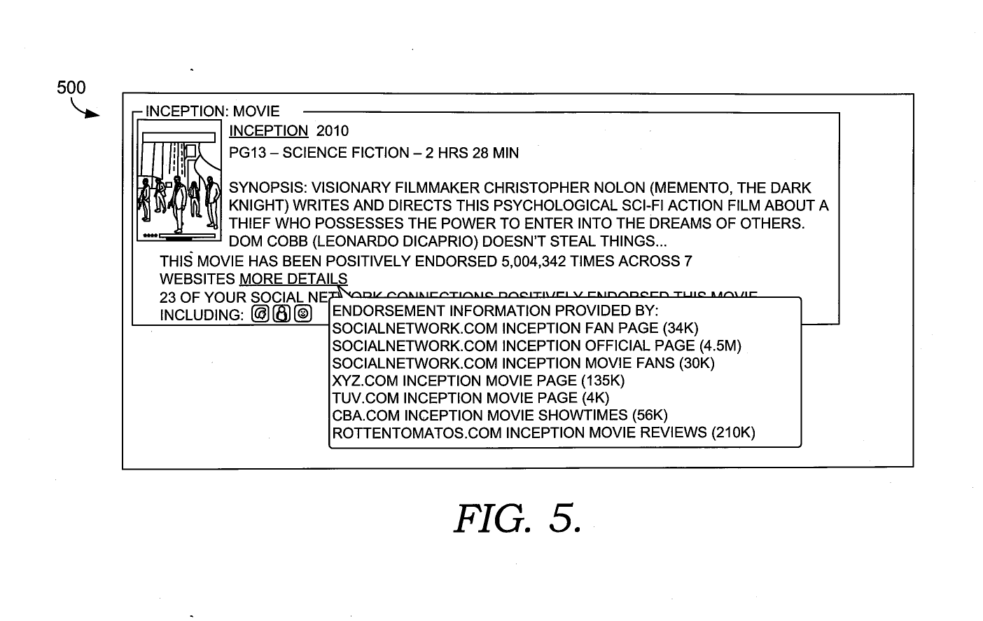

The simplest case for surfacing aggregated endorsement information relates to the presentation of such information for the top-ranking entity associated with an input query by summing the favorable endorsements from known sources contributing to a resolved entity. An exemplary such presentation is shown with reference to the screen display 400 of FIG. 4. Note that endorsement data derived from seven websites has been aggregated for the resolved movie entity INCEPTION such that the sentence “This movie has been positively endorsed 5,004,342 times across 7 websites” is presented. Selection or hovering over the “More Details” link may present a detailed view for all Uniform Resource Locators (URLs) associated with the resolved entity and/or present an actual or estimated quantity of favorable endorsements associated with each contributing source. This is illustrated in the exemplary screen display 500 of FIG. 5.

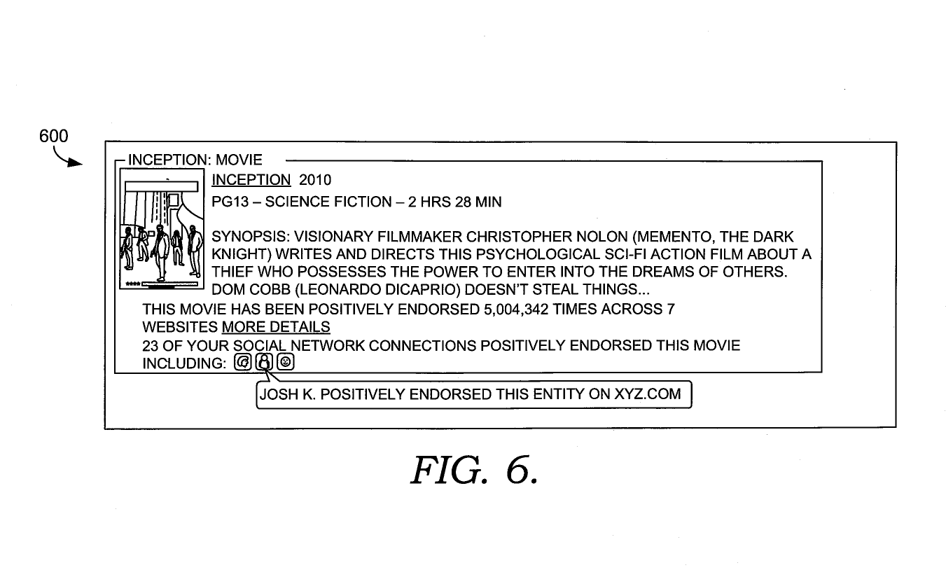

Also illustrated in the exemplary screen display 400 of FIG. 4 is the statement “23 of your social network connections positively endorsed this movie” with iconic representations of some of those social network connections also being presented. In embodiments, selecting or hovering over the representation of a particular social network connection may present the URL from which that particular connection favorably endorsed the movie. This is shown in the exemplary screen display 600 of FIG. 6.

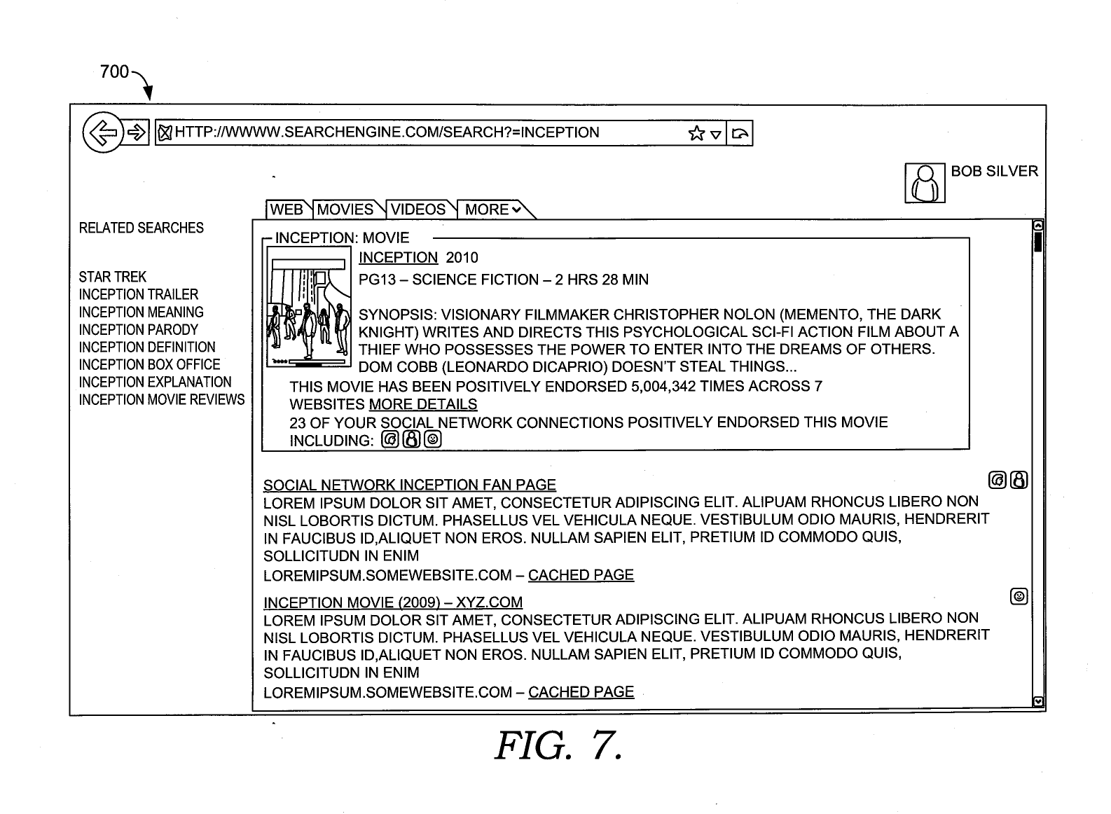

In embodiments, users may be provided with an option to filter search results such that only those URLs related to a resolved entity and having endorsement data associated with the resolved entity are presented. This is shown in the exemplary screen display 700 of FIG. 7, wherein the search results “Social Network Inception Fan Page” and “Inception Movie (2009)—XYZ.COM” are shown indicating that these results have endorsement data for the resolved entity associated therewith. Optionally, and also shown in FIG. 7, iconic representations of one or more social network connections of the user that endorsed the resolved entity may also be presented in association with the search results.

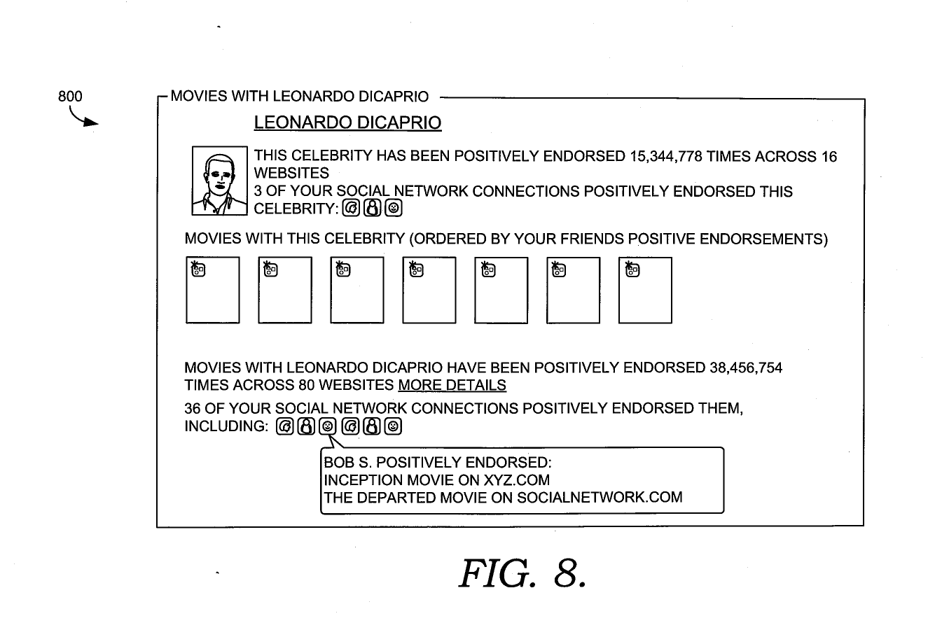

In embodiments, aggregate endorsements may be applied to groups or categories of entities as well. In accordance with such embodiments, aggregate endorsements for all entities that are part of the category or group, as well as a list of the entities that are part of the group may be presented. This is shown in the exemplary screen display 800 of FIG. 8 wherein movies starring Leonardo DiCaprio and the associated endorsement data is presented. The attribute on which the listing of movies was resolved was the actor, Leonardo DiCaprio. Thus, a plurality of movies sharing this attribute have been resolved into a group and the endorsement data associated with each, from a plurality of sources, has been aggregated such that it is indicated that “This celebrity has been positively endorsed 15,344,778 times across 16 websites.” Also shown in the screen display 800 of FIG. 8 are iconic representations of social network connections that have endorsed members of the entity group that may be acted upon (e.g., selected or hovered over) for presentation of additional information, as described herein above with respect to FIG. 6.

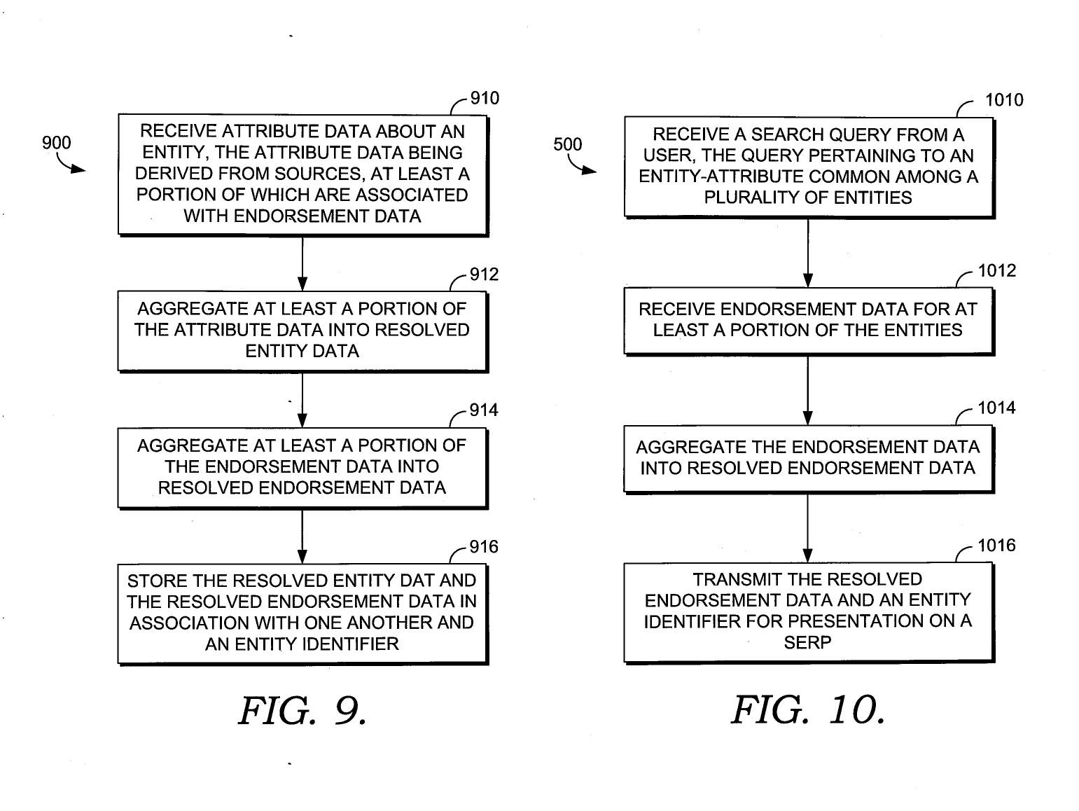

Turning now to FIG. 9, a flow diagram is illustrated showing an exemplary method 900 for performing entity-based aggregation of endorsement data, in accordance with an embodiment of the present invention. Initially, as indicated at block 910, attribute data about an entity is received, the attribute data being derived from a plurality of sources, at least a portion of which are associated with endorsement data. At least a portion of the received attribute data is then aggregated into resolved entity data, as indicated at block 912. As indicated at block 914, also aggregated is at least a portion of the endorsement data, such being merged into resolved endorsement data. The resolved entity data and the resolved endorsement data are then stored in association with one another and in association with an entity identifier for the entity, as indicated at block 916.

In accordance with embodiments of the present invention, similar steps to those described above may be performed to aggregate endorsements with respect to similar entities, for instance, multiple entities having a common attribute, such as movies staring the same actor (as described above with respect to the screen display 800 of FIG. 8). Other examples may include entities having a similar price, category or genre. Utilizing such embodiments, users can compare, for instance, the number of endorsements for action movies starring Clint Eastwood with the number of endorsements for action movies starring Sylvester Stallone. An exemplary method 1000 for performing similar entity endorsement aggregation in accordance with embodiments of the present invention is shown in the flow diagram of FIG. 10.

Initially, as indicated at block 1010, a search query is received form a user, at least a portion of the search query pertaining to an entity-attribute that is common among a plurality of entities. As indicated at block 1012, endorsement data pertaining to at least a portion of the plurality of entities is received, the endorsement data being derived from a plurality of sources. At least a portion of the endorsement data is aggregated into resolved endorsement data pertaining to the entities, as indicated at block 1014. At least a portion of the resolved endorsement data and an identifier of one or more entities of the plurality of entities is transmitted for presentation in association with a search engine results page, as indicated at block 1016.

As can be understood, embodiments of the present invention provide systems and methods for performing entity-attribute-based aggregation of endorsement data. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 900 of FIGS. 9 and 1000 of FIG. 10 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for performing entity-based aggregation of endorsement data, the method comprising:
receiving attribute data about an entity, the attribute data being derived from a plurality of sources at least a portion of which are associated with endorsement data pertaining to the entity;
aggregating at least a portion of the attribute data into resolved entity data pertaining to the entity;
aggregating at least a portion of the endorsement data into resolved endorsement data pertaining to the entity; and
storing the resolved entity data and the resolved endorsement data in association with one another and in association with an entity identifier for the entity.

2. The one or more computer-readable storage media of claim 1, wherein each of the plurality of sources is a website, a webpage, a database record, a file, a data feed, or a network.

3. The one or more computer-readable storage media of claim 1, wherein the endorsement data includes one or more of a favorable endorsement, an unfavorable endorsement and a rating.

4. The one or more computer-readable storage media of claim 1, wherein the method further comprises transmitting at least a portion of the resolved entity data and at least a portion of the resolved endorsement data for presentation in association with a single entity view.

5. The one or more computer-readable storage media of claim 4, wherein transmitting at least the portion of the resolved endorsement data for presentation comprises transmitting a quantity of endorsements for presentation.

6. The one or more computer-readable storage media of claim 5, wherein transmitting at least the portion of the resolved endorsement data for presentation comprises transmitting a quantity of the plurality of sources from which the quantity of endorsements is derived for presentation.

7. The one or more computer-readable storage media of claim 6, wherein transmitting at least the portion of the resolved endorsement data for presentation comprises transmitting an identification of at least one source of the plurality of sources from which the quantity of endorsements is derived for presentation.

8. The one or more computer-readable storage media of claim 7, wherein transmitting at least the portion of the resolved endorsement data for presentation comprises transmitting a source-specific quantity of endorsements for presentation that is attributable to the at least one source of the plurality of sources from which the quantity of endorsements is derived.

9. The one or more computer-readable storage media of claim 4, wherein transmitting at least the portion of the resolved endorsement data for presentation comprises transmitting a quantity of endorsements for presentation that is attributable to social network connections of a user.

10. The one or more computer-readable storage media of claim 9, wherein transmitting at least the portion of the resolved endorsement data for presentation comprises transmitting an identification of at least one social network connection of the user that has endorsed the entity for presentation.

11. The one or more computer-readable storage media of claim 10, wherein transmitting at least the portion of the resolved endorsement data for presentation comprises transmitting an identifier of a source of the plurality of sources in association with which the at least one social network connection of the user endorsed the entity for presentation.

12. A system for performing entity-based aggregation of endorsement data, the system comprising:
a computing device associated with a server having one or more processors and one or more computer-readable storage media; and
a data store coupled with the server,
wherein the server:
receives a search query from a user, at least a portion of the search query pertaining to an entity;
receives attribute data about the entity, the attribute data being derived from a plurality of sources at least a portion of which are associated with endorsement data pertaining to the entity;
aggregates at least a portion of the attribute data into resolved entity data pertaining to the entity;
aggregates at least a portion of the endorsement data into resolved endorsement data pertaining to the entity; and
transmits at least a portion of the resolved entity data and at least a portion of the resolved endorsement data for presentation in association with a search engine results page (SERP).

13. The system of claim 12, wherein the server transmits the at least the portion of the resolved entity data and the at least the portion of the resolved endorsement data for presentation in association with a single entity view on the SERP.

14. The system of claim 12, wherein, as part of the resolved endorsement data, the server transmits a quantity of endorsements attributable to social network connections of the user for presentation in association with the SERP.

15. The system of claim 14, wherein the server transmits an identification of at least one social network connection of the user that has endorsed the entity for presentation in association with the SERP.

16. The system of claim 15, wherein the server transmits an identifier of a source of the plurality of sources in association with which the at least one social network connection of the user endorsed the entity for presentation in association with the SERP.

17. A method being performed by one or more computing devices including at least one processor, for performing entity-attribute-based aggregation of endorsement data, the method comprising:
receiving a search query from a user, at least a portion of the search query pertaining to an entity-attribute that is common among a plurality of entities;
receiving endorsement data pertaining to at least a portion of the plurality of entities, the endorsement data being derived from a plurality of sources;
aggregating at least a portion of the endorsement data into resolved endorsement data pertaining to the at least a portion of the plurality of entities; and
transmitting at least a portion of the resolved endorsement data and an identifier of one or more entities of the at least a portion of the plurality of entities for presentation in association with a search engine results page (SERP).

18. The method of claim 13, wherein at least a portion of the endorsement data is associated with social network connections of the user.

19. The method of claim 18, wherein transmitting the at least the portion of the resolved endorsement data for presentation in association with the SERP comprises transmitting a quantity of endorsements attributable to at least a portion of the social network connections of the user for presentation in association with the SERP.

20. The method of claim 19, wherein transmitting the at least the portion of the resolved endorsement data for presentation in association with the SERP comprises transmitting an identification of at least one social network connection of the user that has endorsed the entity for presentation in association with the SERP.
